(19) United States
(12) Patent Application Publication
(10) Pub. No.: US 2006/0268155 A1
(43) Pub. Date: Nov. 30, 2006

(54) Image pickup apparatus

(75) Inventors: Kiyoshi Takagi, Tokyo (JP); Yoshito Katagiri, Tokyo (JP); Kazusei Takahashi, Osaka (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/438,712

(22) Filed: May 22, 2006

(30) Foreign Application Priority Data
May 25, 2005 (JP) JP2005-152154

(51) Int. Cl. H04N 5/222

(52) U.S. Cl. 348/370

(57) ABSTRACT

In imaging using a linear log sensor and an auxiliary light source, an image pickup apparatus capable of preventing an excess of exposure and suppressing the influence on the brightness of the overall screen even if the distances of a plurality of photographic subjects are different from each other within the arrival range of strobo light is provided. In an image pickup apparatus 1, an image pickup device 4, an irradiation unit 6 for irradiating light at time of picking up an image of a photographic subject, and an inflection point changing unit 25 for changing an inflection point which is a boundary between a linear area and a logarithmic area so as to prevent an output signal of the image pickup device 4 from saturation within the brightness range of the photographic subject and to use the logarithmic area in priority are installed.

This application is based on Japanese Patent Application No. 2005-152154 filed on May 25, 2005, in Japanese Patent Office, the entire content of which is hereby incorporated by reference.

### TECHNICAL FIELD

The present invention relates to an image pickup apparatus and more particularly to an image pickup apparatus having an image pickup device for switching a logarithmic conversion operation and a linear conversion operation.

### BACKGROUND

Conventionally, in imaging by an image pickup apparatus such as a digital camera unit cooperated in a mobile camera, when the circumference of a photographic subject is dark, an auxiliary light source such a strobo device or a high-brightness LED is used.

When imaging using such an auxiliary light source, if there are a main photographic subject where strobo light reaches and a background having a small distance difference, an image pickup apparatus for performing strobo-photography control for making the main photographic subject appropriate is described.

Patent Document 1: Japanese Laid-Open Patent Application HEI7-222049

However, when within the arrival range of the strobo light, there are a plurality of photographic subjects, and the distances to the respective photographic subjects are different from each other, the strobo light quantity given to each photographic subject is varied according to the distance to the photographic subject, so that the strobo light quantities given to each of the photographic subjects is varied, thus a problem arises that no good images can be obtained.

For example, a case that within the appropriate arrival range of the strobo light, there are a photographic subject a positioned at a comparatively short distance from a camera and a photographic subject b positioned at a comparatively long distance is supposed. Here, using the concept of the prior art, assuming either of them as a main photographic subject in an alternative way, for example, when an appropriate strobo light quantity is given to the photographic subject a, a problem arises that the light quantity to the photographic subject b is insufficient and on the other hand, when an appropriate strobo light quantity as a main photographic subject is given to the photographic subject b, a problem arises that an excess of light quantity is given to the photographic subject a. Such a problem remarkably appears in image data particularly at night when the peripheral brightness is low.

Furthermore, to give an appropriate strobo light quantity, even if imaging is executed by combining the exposure conditions such as the stop, shutter, and gain, it only affects the brightness of the overall imaging screen, and for a plurality of photographic subjects existing at different distances, good images cannot be obtained, thus a substantial solution cannot be obtained.

On the other hand, in recent years, an image pickup device (linear log sensor) for switching a linear conversion operation and a logarithmic conversion operation of an electric signal according to an incident light quantity has been proposed. According to such an image pickup device, as compared with an image pickup device (linear sensor) for performing only the linear conversion operation, the dynamic range of the electric signal is widened, so that even when a photographic subject having a wide brightness distribution is imaged, all the brightness information can be expressed by the electric signal.

However, when imaging by use of an irradiation means such as a stroboscope, particularly, as mentioned above, a case that there are a plurality of photographic subjects within the arrival range of strobo light is not given consideration.

### SUMMARY

A problem of the present invention is to provide an image pickup apparatus to obtain good images when executing imaging by a recently introduced image pickup device (linear log sensor) using an auxiliary light source.

In view of forgoing, one embodiment according to one aspect of the present invention is an image pickup apparatus, comprising:

an image pickup device provided with a plurality of pixels for picking up an image of a photographic subject, the image pickup device which has a linear conversion operation in which incident light is linearly converted to an electric signal and a logarithmic conversion operation in which the incident light is logarithmically converted to the electric signal, the liner conversion operation and the logarithmic conversion operation being switchable according to an amount of incident light;

a light irradiation section which throws irradiation light when picking up the image. of the photographic subject; and

an inflection point changing section, when picking up the image of the photographic subject using the light irradiation section, which sets an inflection point which is a boundary between a liner area where the linear conversion operation is functional and a logarithmic area where the logarithmic conversion operation is functional in a manner of putting an priority on a use of the logarithmic area so as to prevent the electric signal outputted from the image pickup device from saturating in a brightness range of the photographic subject.

According to another aspect of the present invention, another embodiment of the present invention is an image pickup apparatus, comprising:

an image pickup device provided with a plurality of pixels for picking up an image of a photographic subject, the image pickup device which has a linear conversion operation in which incident light is linearly converted to an electric signal and a logarithmic conversion operation in which the incident light is logarithmically converted to the electric signal, the liner conversion operation and the logarithmic conversion operation being switchable according to an amount of incident light;

a light irradiation section which throws irradiation light when picking up the image of the photographic subject;

a reflection light amount detection section which detects a reflection light amount from the photographic subject; and

an inflection point changing section, when picking up the image of the photographic subject using the light irradiation section, which sets an inflection point which is a boundary between a liner area where the linear conversion operation is functional and a logarithmic area where the logarithmic conversion operation is functional in a manner of putting an priority on a use of the logarithmic area for preventing the electric signal outputted from the image pickup device from saturating in a brightness range of a photographic subject which has the largest reflection light amount detected by the reflection light amount detection section in case that a plurality of photographic subjects exist within an arrival range of the irradiation light of the light irradiation section.

### BRIEF DESCRIPTION OF THE DRAWINGS

FIG. 1 is a front view showing the constitution of the image pickup apparatus relating to the embodiment of the present invention.

FIG. 2 is a plan view showing the constitution of the line sensor relating to the embodiment of the present invention.

FIG. 3 is a rear view showing the constitution of the image pickup apparatus relating to the embodiment of the present invention.

FIG. 4 is a block diagram showing the functional constitution of the image pickup apparatus relating to the embodiment of the present invention.

FIG. 5 is a block diagram showing the constitution of the image pickup device relating to the embodiment of the present invention.

FIG. 6 is a circuit diagram showing the constitution of the pixels included in the image pickup device relating to the embodiment of the present invention.

FIG. 7 is a time chart showing the operation of the pixels included in the image pickup device relating to the embodiment of the present invention.

FIG. 8 is a graph showing the output of the pixels of the image pickup device relating to the embodiment of the present invention for the incident light quantity.

FIG. 9 is a graph showing an example of the reflected light quantity of the irradiation light of the irradiation unit of the embodiment of the present invention according to the distance of a photographic subject.

FIG. 10 is a graph showing the inflection point of the output of the image pickup device relating to the embodiment of the present invention.

FIG. 11 is a flow chart showing the operation of the image pickup apparatus relating to the embodiment of the present invention.

### DETAILED DESCRIPTION OF THE PREFERRED EMBODIMENT

The embodiment of the present invention will be explained with reference to the accompanying drawings.

An image pickup apparatus 1 relating to this embodiment is a compact type digital camera and the image pickup apparatus of the present invention includes electronic devices having imaging functions such as a single-lens reflex digital camera, a portable telephone with camera, and a mobile camera and also a camera unit incorporated in the electronic devices such the portable telephone and mobile camera.

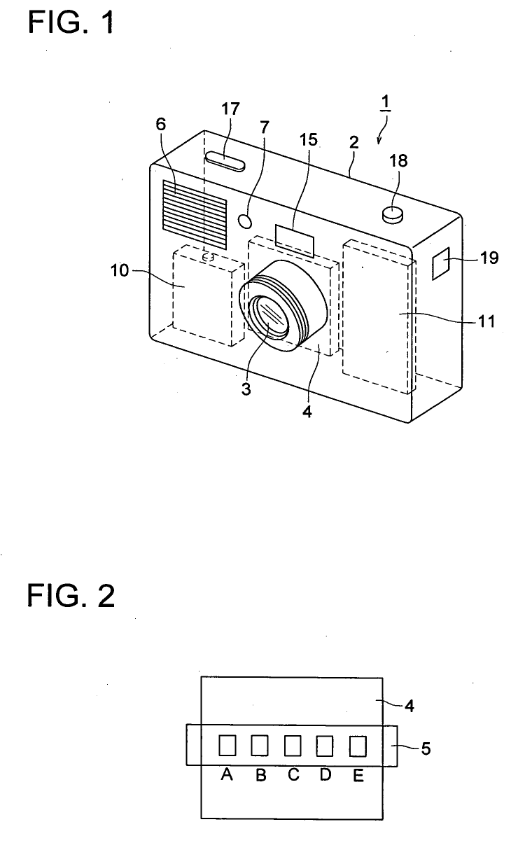

As shown in FIG. 1, in the neighborhood of the center of the front of a frame 2 included in the image pickup apparatus 1, a lens unit 3 for focusing image light of a photographic subject to a predetermined focal point is installed so that the optical axis of the lens unit 3 intersects the front of the frame 2 orthogonally. And, inside the frame 2 and behind the lens unit 3, an image pickup device 4 for converting photoelectrically reflected light of the photographic subject entering via the lens unit 3 to an electric signal is installed.

Further, as shown in FIG. 2, in the neighborhood of the image pickup device 4, a line sensor 5 is arranged so as to have the same imaging view angle as that of the image pickup device 4. The line sensor 5, in areas A to E corresponding to the respective areas in the imaging screen, receives reflected light of the photographic subject in each area in the imaging screen. Further, the image pickup device 4 may be used as a line sensor.

Further, as shown in FIG. 1, in the neighborhood of the upper end of the front of the frame 2, an irradiation unit 6 for irradiating light at time of image pickup is installed. The irradiation unit 6 of this embodiment is composed of a stroboscope built in the image pickup apparatus 1, though it may be composed of an external stroboscope or a high-brightness LED. Further, on the front of the frame 2 and in the neighborhood of the upper part of the lens unit 3, a light sensor 7 is installed and it receives reflected light of light irradiated from the irradiation unit 6 to the photographic subject.

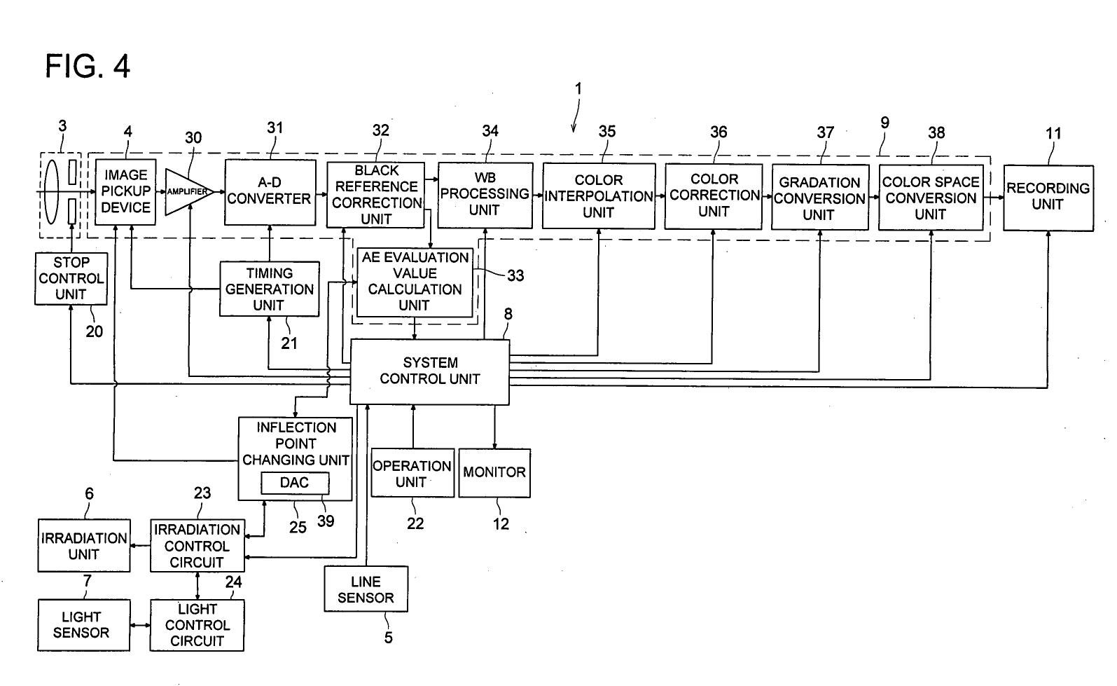

Furthermore, inside the frame 2 included in the image pickup apparatus 1, a circuit substrate (not drawn) including circuits such as a system control unit 8 and a signal processing unit 9 (both are shown in FIG. 4) is installed. Further, inside the frame 2, a battery 10 is built in and a recording unit 11 such as a memory card is loaded.

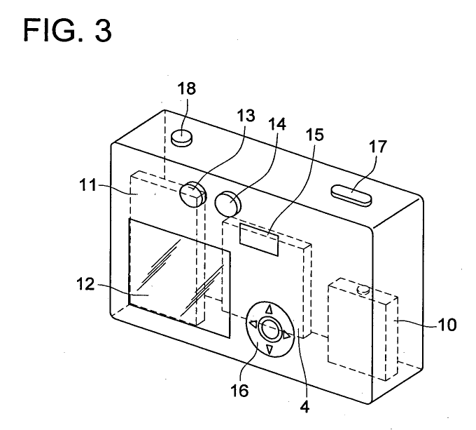

Further, as shown in FIG. 3, on the back of the frame 2, an image display monitor 12 is installed. The monitor 12 is composed of a liquid crystal display (LCD) and a cathode ray tube (CRT) and can display a preview screen of a photographic subject and a picked-up image thereof.

Further, in the neighborhood of the upper end of the back of the image pickup apparatus 1, a zoom button W13 (wide angle) and a zoom button T14 (telephoto) for adjusting zooming are installed. Further, on the back of the image pickup apparatus 1 and above the position of the lens unit 3, an optical finder 15 for confirming a photographic subject from the back side of the frame 2 is arranged.

Furthermore, in the neighborhood of the central part of the back of the image pickup apparatus 1, a selection cross key 16 having a cross key for moving a cursor or a window displayed on the screen of the monitor 12 or changing the designation range of the window is installed. Further, at the central part of the selection cross key 16, a decision key for deciding the contents designated by the cursor or window is installed.

Further, on the top of the image pickup apparatus 1 and between the battery 10 and the lens unit 3, a release switch 17 for releasing the shutter is installed. The release switch 17 can perform an operation of “half pressing” of pressing part of the way and an operation of “full pressing” of pressing furthermore.

Further, in the neighborhood of the top end of the frame 2, a power switch 18 for turning on (start) or off (stop) the power source of the image pickup apparatus 1 by pressing down is installed.

Further, in the neighborhood of the upper end of one side of the frame 2, a USB terminal 19 for connecting a USB cable for connecting the image pickup apparatus 1 to a personal computer is installed.

Next, the functional constitution of the image pickup apparatus 1 is shown in FIG. 4.

As mentioned above, the image pickup apparatus 1 has the system control unit 8 on the circuit substrate inside the frame 2. The system control unit 8 is composed of a central processing unit (CPU), a random access memory (RAM) composed of a rewritable semiconductor device, and a read only memory (ROM) composed of a nonvolatile semiconductor memory.

Further, to the system control unit 8, the components of the image pickup apparatus 1 are. connected and the system control unit 8 stores a processing program recorded in the ROM in the RAM, executes the processing program by the CPU, thereby drives and controls the components.

As shown in FIG. 4, to the system control unit 8, the lens unit 3, a stop control unit 20, an image pickup device 4, the signal processing unit 9, a timing generation unit 21, the recording unit 11, the irradiation unit 6, an irradiation control circuit 23, the light sensor 7, a light control circuit 24, the line sensor 5, the monitor 12, an operation unit 22, and an inflection point changing unit 25 are connected.

The, lens unit 3 is composed of a plurality of lenses for focusing an optical image of a photographic subject on the image pickup screen of the image pickup device 4 and a stop for adjusting the quantity of light focused by the lenses.

The stop control unit 20 drives and controls the stop for adjusting the quantity of light focused by the lenses of the lens unit 3. Namely, the stop control unit 20, on the basis of a control value input from the system control unit 8, closes the stop after a lapse of predetermined exposure time after opening the stop immediately before start of the image pickup operation of the image pickup device 4 and at time of non-image pickup, interrupts incident light to the image pickup device 4, thereby controls the incident light quantity.

The image pickup device 4 converts photoelectrically and fetches incident light of each color component of R, G, and B of the optical image of the photographic subject to an electric signal.

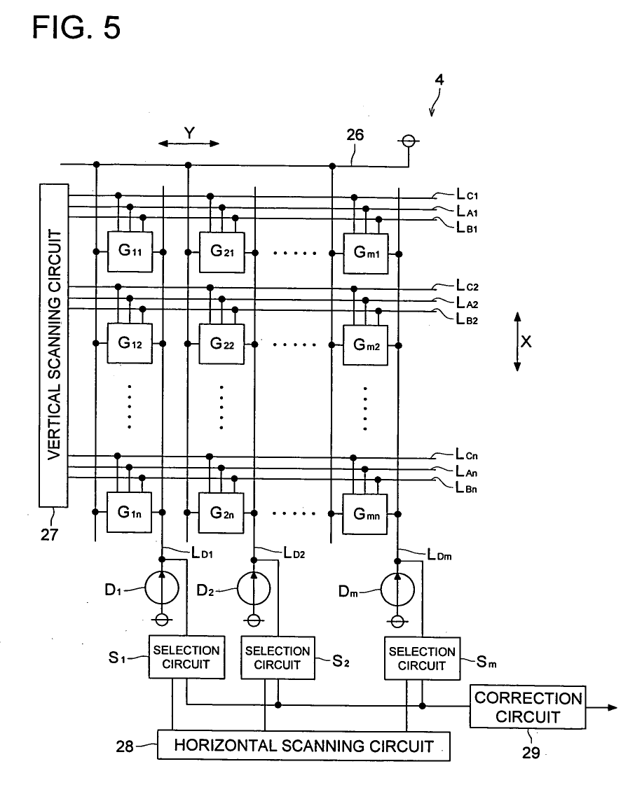

As shown in FIG. 5, the image pickup device 4 has a plurality of pixels. G₁₁ to Gₘₙ (n and m are integers of 1 or larger) arranged in a matrix (matrix arrangement).

Each of the pixels G₁₁ to Gₘₙ converts photoelectrically incident light and outputs an electric signal. These pixels G₁₁ to Gₘₙ can switch the conversion operation of an electric signal according to an incident light quantity and more in detail, switch a linear conversion operation for linearly converting incident light to an electric signal and a logarithmic conversion operation for logarithmically converting it. Further, in this embodiment, linear conversion or logarithmic conversion of incident light to an electric signal is linear conversion to an electric signal for changing linearly a time integral value of the light quantity or logarithmic conversion to an electric signal for changing logarithmically it.

On the side of the lens unit 3 of the pixels G₁₁ to Gₘₙ, a filter (not drawn) of one color among red, green, and blue is respectively arranged. Further, to the pixels G₁₁ to Gₘₙ, as shown in FIG. 5, power lines 26, signal impression lines L_{A1} to L_{An}, L_{B1} to L_{Bn}, and L_{C1} to L_{Cn}, and signal reading lines L_{D1} to L_{Dm} are connected. Further, to the pixels G₁₁ to Gₘₙ, lines such as a clock line and bias supply line are connected, though they are not shown in FIG. 5.

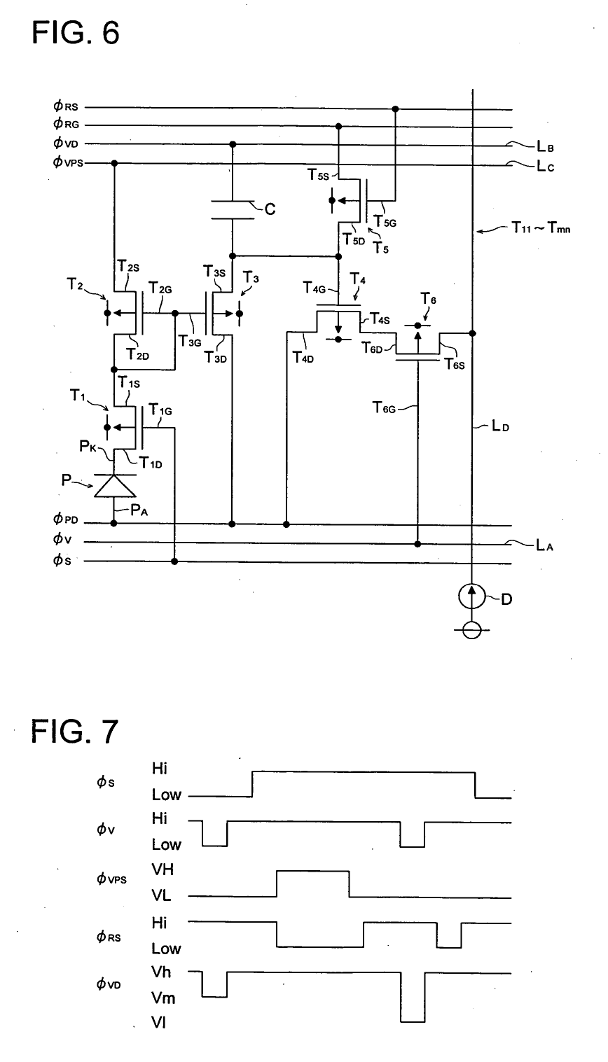

The signal impression lines L_{A1} to L_{An}, L_{B1} to L_{Bn} and L_{C1} to L_{Cn} give signals φ_{V}, φ_{VD}, and φ_{VPS} (refer to FIGS. 6 and 7) to the pixels G₁₁ to Gₘₙ. To these signal impression lines L_{A1} to L_{An}, L_{B1} to L_{Bn}, and L_{C1} to L_{Cn}, a vertical scanning circuit 27 is connected. The vertical scanning circuit 27, on the basis of a signal from the timing generation unit 21 (refer to FIG. 4), impresses a signal to the signal impression lines L_{A1} to L_{An}, L_{B1} to L_{Bn}, and L_{C1} to L_{Cn} and switches the signal impression lines L_{A1} to L_{An}, L_{B1} to L_{Bn}, and L_{C1} to L_{Cn} to be impressed the signal sequentially in the X direction.

To the signal reading lines L_{D1} to L_{Dm}, an electric signal generated by each of the pixels G₁₁ to Gₘₙ is derived. To the signal reading lines L_{D1} to L_{Dm}, constant-current sources D₁ to Dₘ and selection circuits S₁ to Sₘ are connected. Further, to one end of each of the constant-current sources D₁ to Dm (the lower ends shown in the drawing), a DC voltage V_{PS} is impressed.

The selection circuits S₁ to Sₘ sample-hold nozzle signals given from the pixels G₁₁ to Gₘₙ via the signal reading lines L_{D1} to L_{Dm} and an electric signal at time of image pickup. To the selection circuits S₁ to Sₘ, a horizontal scanning circuit 28 and a correction circuit 29 are connected. The horizontal scanning circuit 28 switches sequentially the selection circuits S₁ to Sₘ for sample-holding an electric signal and transmitting it to the correction circuit 29 in the Y direction. Further, the correction circuit 29, on the basis of noise signals transmitted from the selection circuits S₁ to Sₘ and the electric signal at time of image pickup, remove the noise signals from the concerned electric signal.

Further, for the selection circuits S₁ to Sₘ and the correction circuit 29, the ones disclosed in Japanese Patent Application 2001-223948 can be used. Further, in this embodiment, the case that for the whole selection circuits S₁ to Sₘ, one correction circuit 29 is installed is described, though one correction circuit 29 may be installed for each of the selection circuits S₁ to Sₘ.

Then, the pixels G₁₁ to Gₘₙ included in the image pickup device 4 will be explained.

Each of the pixels G₁₁ to Gₘₙ, as shown in FIG. 6, has a photodiode P, transistors T₁ to T₆, and a capacitor C. Further, the transistors T₁ to T₆ are MOS transistors of channel P.

To the photodiode P, light passing through the lens unit 3 is irradiated. To an anode P_{A} of the photodiode P, a DC voltage V_{PD} is impressed and to a cathode P_{K}, a drain T_{1D} of the transistor T₁ is connected.

To a gate T_{1G} of the transistor T₁, a signal φₛ is input and to a source T_{1S}, a gate T_{2G} and a drain T_{2D} of the transistor T₂ are connected.

To a source T_{2S} of the transistor T₂, a signal impression line L_{C} (equivalent to L_{C1} to L_{Cn} shown in FIG. 5) is connected and a signal φ_{VPS} is input from the signal impression line L_{C}. Here, as shown in FIG. 7, the signal φ_{VPS} is a binary voltage signal and more in detail, it takes two values such as a voltage VL for operating the transistor T₂ in the sub-threshold area when the incident light quantity is larger that a predetermined incident light quantity th and a voltage VH for putting the transistor T₂ into the continuity state.

To the source T_{1S} of the transistor T₁, a gate T_{3G} of the transistor T₃ is connected.

To a drain T_{3D} of the transistor T₃, a DC voltage V_{PD} is impressed. Further, to a source T_{3S} of the transistor T₃, one end of the capacitor C, a drain T_{5D} of the transistor T₅, and a gate T_{4G} of the transistor T₄ are connected.

To the other end of the capacitor C, a signal impression line L_{B} (equivalent to L_{B1} to L_{Bn} shown in FIG. 5) is connected and a signal φ_{VD} is given from the signal impression line L_{B}. Here, as shown in FIG. 7, the signal φ_{VD} is a ternary voltage signal and more in detail, it takes three values such as a voltage Vh when making the capacitor C perform an integral operation, a voltage Vm when reading an electric signal photoelectrically converted, and a voltage Vl when reading a noise signal.

To a source T_{5S} of the transistor T₅, a DC voltage V_{RG} is input and to a gate T_{5G} thereof, a signal φ_{RS} is input.

To a drain T_{4D} of the transistor T₄, the DC voltage V_{PD} is impressed in the same as with the drain T_{3D} of the transistor T₃ and to a source T_{4S} thereof, a drain T_{6D} of the transistor T₆, is connected.

To a source T_{6S} of the transistor T₆, a signal reading line L_{D} (equivalent to L_{D1} to L_{Dm} shown in FIG. 5) is connected and to a gate T_{6G} thereof, a signal φ_{V} is input from a signal impression line L_{A} (equivalent to L_{A1} to L_{An} shown in FIG. 5).

By use of such a circuit constitution, the pixels G₁₁ to Gₘₙ perform the following reset operation.

Firstly, as shown in FIG. 7, the vertical scanning circuit 27 perform the reset operation of the pixels G₁₁ to Gₘₙ.

Concretely, in the state that the signal φ_{S} is low, and the signal φ_{V} is high, and the signal φ_{VPS} is very low, and the signal φ_{RS} is high, and the signal φ_{VD} is very high, the vertical scanning circuit 27 gives the pulse signal φ_{V} and the pulse signal φ_{VD} of the voltage Vm to the pixels G₁₁ to Gₘₙ so as to output an electric signal to the signal reading line L_{D} and then makes the signal φ_{S} high and turn off the transistor T₁.

Next, when the vertical scanning circuit 27 makes the signal φ_{VPS} very high, the negative charges accumulated in the gate T_{2G} and drain T_{2D} of the transistor T₂ and the gate T_{3G} of the transistor T₃ are recoupled promptly. Further, when the vertical scanning circuit 27 makes the signal φ_{RS} low and turns on the transistor T₅, the voltage of the node between the capacitor C and the gate T_{4G} of the transistor T₄ is initialized.

Next, the vertical scanning circuit 27 makes the signal φ_{VPS} very low, thereby returns the potential state of the. transistor T₂ to its original state, then makes the signal φ_{RS} high, and turns off the transistor T₅. Next, the capacitor C performs the integral operation. By doing this, the voltage of the node between the capacitor C and the gate T_{4G} of the transistor T₄ corresponds to the gate voltage of the transistor T₂.

Next, when the vertical scanning circuit 27 gives the pulse signal φ_{V} to the gate T_{6G} of the transistor T₆, the transistor T₆ is turned on and the pulse signal φ_{VD} of the voltage V1 is impressed to the capacitor C. At this time, the transistor T₄ operates as a source follower type MOS transistor, so that a noise signal appears on the signal reading line L_{D} as a voltage signal.

And, the vertical scanning circuit 27 gives the pulse signal φ_{RS} to the gate T_{5G} of the transistor T₅, resets the voltage of the node between the capacitor C and the gate T_{4G} of the transistor T₄, and then makes the signal φ_{S} low, and turns on the transistor T₁. By doing this, the reset operation is completed and the pixels G₁₁ to Gₘₙ enter the image pickup ready state.

Further, the pixels G₁₁ to Gₘₙ perform the following image pickup operation.

When an optical charge according to the incident light quantity flows into the transistor T₂ from the photodiode P, the optical charge is accumulated in the gate T_{2G} of the transistor T₂.

Here, when the brightness of a photographic subject is low and the incident light quantity to the photodiode P is smaller than the predetermined incident light quantity th, the transistor T₂ is in the cut-off state, so that a voltage according to the optical charge quantity accumulated in the gate T_{2G} of the transistor T₂ appears in the concerned gate T_{2G}. Therefore, on the gate T_{3G} of the transistor T₃, the voltage for linearly converting the incident light appears.

On the other hand, when the brightness of the photographic subject is high and the incident light quantity to the photodiode P is larger than the predetermined incident light quantity th, the transistor T₂ operates in the sub-threshold area. Therefore, in the gate T_{3G} of the transistor T₃, the voltage for converting natural-logarithmically the incident light appears.

Further, in this embodiment, between the pixels G₁₁ to Gₘₙ, the predetermined value is equal.

When the voltage appears in the gate T_{3G} of the transistor T₃, the current flowing from the capacitor C to the drain T_{3D} of the transistor T₃ is amplified according to the voltage. Therefore, in the gate T_{4G} of the transistor T₄, the voltage for linearly or logarithmically converting the incident light of the photodiode P appears.

Next, the vertical scanning circuit 27 sets the voltage of the signal φ_{VD} to Vm and makes the signal φ_{V} low. By doing this, a source current according to the gate voltage of the transistor T₄ flows to the signal reading line L_{D} via the transistor T₆. At this time, the transistor T₄ operates as a source follower type MOS transistor, so that in the signal reading line L_{D}, the electric signal at time of image pickup appears as a voltage signal. Here, the signal value of the electric signal outputted via the transistors T₄ and T₆ is a value in proportion to the gate voltage of the transistors T₄, so that the concerned signal value is a value when the incident light of the photodiode P is converted linearly or logarithmically.

And, the vertical scanning circuit 27 sets the voltage of the signal φ_{VD} to Vh and makes the signal φ_{V} high, thus the image pickup operation ends.

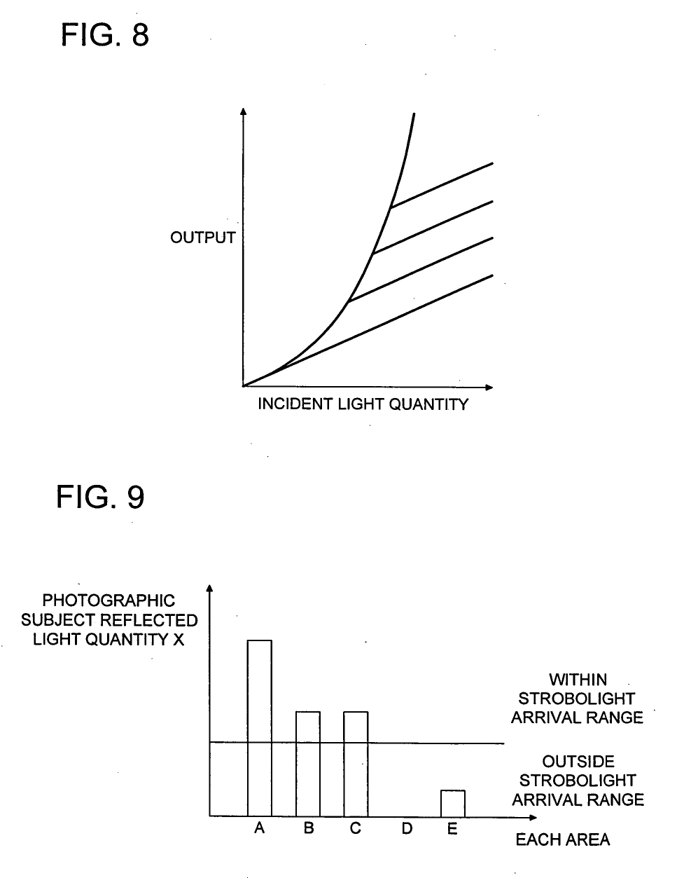

When such an operation is performed, the voltage VL of the signal φ_{VPS} at time of image pickup is lowered, and as the difference from the voltage VH of the signal φ_{VPS} at time of reset is increased, the difference in the potential between the gate and the source of the transistor T₂ is increased, and the rate of the brightness of the photographic subject when the transistor T₂ operates in the cut-off state is increased. Therefore, as shown in FIG. 8, as the voltage VL is lowered, the rate of the. brightness of the photographic subject converting linearly is increased. As mentioned above, with respect to the output signal of the image pickup device 4 relating to this embodiment, the linear area and logarithmic area are continuously changed according to the incident light quantity.

Therefore, for example, when the brightness range of the photographic subject is narrow, the voltage VL is lowered so as to extend the linear conversion brightness range, and when the brightness range of the photographic subject is wide, the voltage VL is increased so as to extend the logarithmic conversion brightness range, thus a photoelectric conversion characteristic in accordance with the characteristic of the photographic subject can be set. Further, when minimizing the voltage VL, the linear conversion state can be set always and when maximizing the voltage VH, the logarithmic conversion state can be set always.

When switching the voltage VL of the signal φ_{VPS} given to the pixels G₁₁ to Gₘₙ of the image pickup apparatus 1 operating like this, the dynamic range can be switched. Namely, when the system control unit 8 switches the voltage VL of the signal φ_{VPS}, the inflection point where the linear conversion operation of the pixels G₁₁ to Gₘₙ is switched to the logarithmic conversion operation can be changed.

Further, the image pickup device 4 relating to this embodiment may automatically switch the linear conversion operation and logarithmic conversion operation for each pixel and it may have pixels using a different constitution from that shown in FIG. 6.

Further, in this embodiment, the value VL of the signal φ_{VPS} at time of image pickup is changed, thus the linear conversion operation and logarithmic conversion operation are switched. However, the value VL of the signal φ_{VPS} at time of reset is changed, thus the inflection point between the linear conversion operation and the logarithmic conversion operation may be changed. Furthermore, the reset time is changed, thus the inflection point between the linear conversion operation and the logarithmic conversion operation may be changed.

Further, the image pickup device 4 of this embodiment has the R, G, and B filters for each pixel, though it may have filters of other colors such as cyan, magenta, and yellow.

In FIG. 4 again, the signal processing unit 9 is composed of an amplifier 30, an A-D converter 31, a black reference correction unit 32, an AE evaluation value calculation unit 33, a WB processing unit 34, a color interpolation unit 35, a color correction unit 36, a gradation conversion unit 37, and a color space conversion unit 38.

Among them, the amplifier 30 amplifies an electric signal outputted from the image pickup device 4 to a predetermined specified level and compensates for the insufficient level of a picked-up image.

Further, the A-D converter 31 (ADC) converts the electric signal amplified by the amplifier 30 from an analog signal to a digital signal.

Further, the black reference correction unit 32 corrects the black level which is a lowest brightness value to the reference value. Namely, the black level varies with the dynamic range of the image pickup device 4, so that the signal level of the black level is subtracted from the signal level of each of R, G, and B signals outputted from the A-D converter 31, thus the black reference correction is performed.

Further, the AE evaluation calculation unit 33 detects an evaluation value necessary for automatic exposure (AE) from an electric signal after black reference correction. Namely, it confirms the brightness value of the electric signal composed of the primary color components of R, G, and B, thereby calculates a mean value distribution range of the brightness indicating the brightness range of the photographic subject, outputs it to the system control unit 8 as an AE evaluation value for setting the incident light quantity, and outputs it to the inflection point changing unit 25 as photographic subject information.

Further, the WB processing unit 34 calculates a correction coefficient from the electric signal after black reference correction, thereby adjusts the level ratios of the color components of R, G, and B of the picked-up image (R/G, B/G), and correctly displays the white.

Further, the color interpolation unit 35, when signals obtained from the pixels of the image pickup device 4 are composed of only one or two colors among the primary colors, to obtain color component values of R, G, and B of each pixel, performs a color interpolation process of interpolating the missing color component(s) for each pixel.

Further, the color correction unit 36 corrects the color component values for each pixel of the image data input from the color interpolation unit 35 and generates an image emphasizing the color tone of each pixel.

Further, the gradation conversion unit 37, to faithfully reproduce an image and to realize an ideal gradation reproduction characteristic assuming the gamma as 1 between input of the image and final output thereof, performs a gamma correction process of correcting the gradation response characteristic of the image to an optimum curve according to the gamma value of the image pickup apparatus 1.

Further, the color space conversion unit 38 converts the color space from R, G, and B to Y, U, and V. To Y, U, and V, a control method for representing a color by two chromaticities of a brightness (Y) signal, a blue color difference (U, Cb), and a red color difference (V, Cr) is applied and when the color space is converted to Y, U, and V, data compression of only a color difference signal can be performed easily.

Next, the timing generation unit 21 controls the image pickup operation (accumulating charge on the basis of exposure and reading the accumulated charge) by the image pickup device 4. Namely, on the basis of an image pickup control signal from the system control unit 8, the timing generation unit 21 generates a predetermined timing pulse (a pixel drive signal, a horizontal synchronous signal, a vertical synchronous signal, a horizontal scanning circuit drive signal, a vertical scanning circuit drive signal, etc.) and outputs it to the image pickup device 4. Further, the timing generation unit 21 generates an A-D conversion timing signal used by the A-D converter 31.

The recording unit 11 is a recording memory composed of a semiconductor memory and has an image data recording area for recording image data input from the signal processing unit 9. The recording unit 11, for example, may be a built-in memory such as a flash memory or a removable memory card or memory disk and may be a magnetic recording medium such as a hard disk or a floppy (registered trademark) disk.

The monitor 12 fulfills a function as a display unit and displays a preview image of a photographic subject and a text screen such a menu screen to select a function by a user.

The operation unit 22 is composed of a zoom button W13, a zoom button T14, the selection cross key 16, the release switch 17, and the power switch 18. When the operation unit 22 is operated, an instruction signal corresponding to each button or switch function is transmitted to the system control unit 8 and according to the instruction signal, each component of the image pickup apparatus 1 is driven and controlled.

Among the aforementioned units, the zoom button W13, when pressed, fulfills a function for adjusting the zoom and displaying small a photographic subject and the zoom button T14, when pressed, fulfills a function for adjusting the zoom and displaying large a photographic subject.

Further, the selection cross key 16, when the cross key is pressed, moves the cursor, selects the image pickup mode or strobo mode, and when the central part is pressed, can confirm the selection contents.

Further, the release switch 17 starts the photometry operation by “half pressing” and starts a series of imaging operations including preliminary imaging and real imaging by “full pressing”.

Further, the power switch 18, whenever pressed, sequentially repeats to turn on or off the image pickup apparatus 1.

The stroboscope as an irradiation unit 6, at time of preliminary imaging, irradiates preliminarily the light quantity of 1/n of the irradiation quantity at time of real irradiation. The irradiation quantity at this time is desirably a one of almost preventing saturation of the output of the image pickup device 4. Further, the stroboscope as an irradiation unit 6, when the brightness of the surrounding environment is insufficient at time of real imaging, performs real irradiation at predetermined irradiation timing and at a predetermined irradiation quantity.

The irradiation control circuit 23 accumulates a charge in order to allow the irradiation unit 6 to irradiate and on the basis of an instruction signal from the system control unit 8, allows the irradiation unit 6 to irradiate.

The light sensor 7 detects strobo light irradiated from the irradiation unit 6 and outputs the detection results to the light control circuit 24.

The light control circuit 24, to integrate the output from the light sensor 7 and dim the irradiation quantity of the irradiation unit 6, outputs the integral value to the irradiation control circuit 23.

The line sensor 5 is, for example, an area sensor or a surface sensor, and as shown in FIG. 2, receives reflected light of a photographic subject in the predetermined areas A to E, and transmits the respective received light quantities to the system control unit 8. In this embodiment, the line sensor 5 detects and transmits a sensor received light quantity (i) of reflected light of a photographic subject in imaging when the stroboscope as an irradiation unit 6 is not used at time of preliminary imaging and a sensor received light quantity (ii) of reflected light of a photographic subject in imaging when preliminarily irradiated by the stroboscope in the respective areas A to E. Further, when detecting reflected light of a photographic subject in the predetermined areas A to E using the image pickup device 4, the line sensor 5 such as the area sensor is not required.

The system control unit 8, when the power source of the image pickup apparatus 1 is turned on, picks up images by the image pickup device 4 every predetermined cycle, for example, every 15 fps and successively displays the picked-up images on the monitor 12 as preview screens. In this case, automatic exposure can be performed every time.

Further, the system control unit 8, from the AE evaluation value obtained from the picked-up images of the preview screens, for example, the mean brightness value of all the screens of the monitor 12, decides the stop value, shutter speed, and imaging sensitivity which are exposure conditions of the real imaging.

Further, the system control unit 8 judges whether or not to use the stroboscope as an irradiation unit 6 at time of imaging. For example, the system control unit 8 calculates the mean brightness value of all the preview screens from the AE evaluation value and when the mean brightness value is not larger than a predetermined brightness value, judges use of the stroboscope at time of imaging.

Further, the system control unit 8, in the preliminary imaging, executes imaging without using the stroboscope under the exposure condition at time of the real imaging and then executes imaging by preliminary irradiation at a light quantity of 1/n of that of the real irradiation. And, the system control unit 8, when receiving, from the line sensor 5, a sensor received light quantity (i) of reflected light of a photographic subject in imaging when the stroboscope is not used and a sensor received light quantity (ii) of reflected light of a photographic subject in imaging after preliminary irradiation, obtains the difference between the sensor received light quantity (i) and the sensor received light quantity (ii), thereby calculates a reflected light quantity X according to the distance of the photographic subject in the respective areas A to E. The reflected light quantity X is reduced as the distance between the image pickup apparatus 1 and the photographic subject is increased and here, the intrinsic reflection factor of the photographic subject is not considered. In FIG. 9, an example of the reflected light quantity X according to the distance of the photographic subject in each area is shown.

Further, the system control unit 8 judges whether there are photographic subjects within the arrival range of strobo light or not. As a result, when judging that there are no photographic subjects given contribution of the strobo light, the system control unit 8 sets the strobo light quantity at time of real imaging as a maximum.

Further, the system control unit 8, when there is one photographic subject within the arrival range of strobo light, decides the photographic subject as a main photographic subject and as a strobo light quantity at time of real imaging, sets a strobo light quantity for making the exposure quantity of the decided main photographic subject appropriate.

Further, the system control unit 8, when there are a plurality of photographic subjects within the arrival range of strobo light, decides the photographic subject having a smallest reflected light quantity X within the arrival range of strobo light as a main photographic subject and sets a strobo light quantity for making the exposure quantity of the decided main photographic subject appropriate.

At this time, the system control unit 8 judges whether there are differences in the reflected light quantity X according to the distance of each photographic subject within the arrival range of strobo light or not, and when there are no differences, judges as the same photographic subject, and when there are differences, judges as different photographic subjects. For example, in FIG. 9, there are a plurality of ranges such as A, B, and C within the arrival range of strobo light, and among them, the reflected light quantities X received in the areas B and C are the same, so that the photographic subjects corresponding to these areas are judged as the same photographic subject. On the other hand, the photographic subject corresponding to the area A is judged as a different photographic subject. And, the photographic subjects corresponding to the areas B and C where the received reflected light quantities X are minimum are decided as a main photographic subject.

The inflection point changing unit 25, in picking up an image in the photometry operation and preliminary imaging, minimizes the voltage VL impressed to the image pickup device 4, thereby can always make the image pickup device 4 perform the linear conversion operation, and can put the image pickup device 4 into the state capable of performing both linear conversion operation and logarithmic conversion operation. When always performing the linear conversion operation, in picking up an image in the photometry operation and preliminary imaging, the contrast of the picked-up image has privilege. Further, the inflection point changing unit 25, on the basis of the AE evaluation value calculated whenever the preview screen is picked up, to prevent the high-brightness area of an output signal of the image pickup device 4 from saturation, can be structured so as to change the inflection point every time.

Further, the inflection point changing unit 25, when the system control unit 8 judges that there are no photographic subjects within the arrival range of strobo light or when it judges that there is one photographic subject within the arrival range of strobo light, to give priority to the contrast, for real imaging, minimizes the voltage VL impressed to the image pickup device 4 and always puts the image pickup device 4 into the state of performing the linear conversion operation.

Further, the inflection point changing unit 25, when the system control unit 8 judges that there are a plurality of photographic subjects within the arrival range of strobo light, changes the inflection point so as to prevent the output signal from saturation within the brightness range of a sub-photographic subject having a largest reflected light quantity X within the arrival range of strobo light, thus the brightness range of the sub-photographic subject is positioned in the logarithmic area. In this embodiment, to prevent the output signal from saturation within the brightness range of the area A shown in FIG. 9, the inflection point is changed. Namely, as mentioned above, the strobo light quantity is set so as to make the exposure quantity of the main photographic subject having a smallest reflected light quantity X within the arrival range of strobo light appropriate, so that a sub-photographic subject having a larger reflected light quantity X than it is given an excess of exposure quantity. However, when the inflection point is changed so as to prevent the output signal from saturation within the brightness range of the sub-photographic subject having a largest reflected light quantity X, an output signal of another sub-photographic subject will not be saturated.

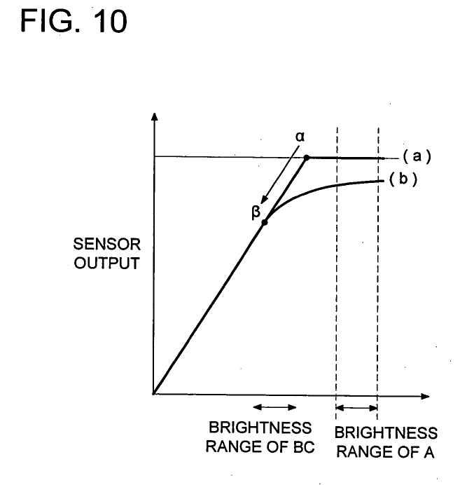

FIG. 10 is a graph showing the output signal of the image pickup device 4 for the brightness value of the photographic subject. In the graph (a), the brightness distribution of the area A reaches the saturation area of the output signal of the image pickup device 4. Therefore, the image data of the sub-photographic subject corresponding to the area A cannot be obtained. Therefore, as shown in FIG. 10, to move an inflection point α shown in the graph (a) to the position of an inflection point β, the inflection point is moved down. By doing this, the output signal of the image pickup device 4 becomes the graph (b) and the brightness distribution of the area A is positioned in the logarithmic area. In this way,. for the sub-photographic subject positioned at a shorter distance than the main photographic subjects corresponding to the areas B and C, the output signal of the image pickup device 4 is prevented from saturation and overexposure of a picked-up image can be prevented.

Next, the inflection point changing unit 25, to change the inflection point of the image pickup device 4 to the decided inflection point, calculates the voltage VL to be set in the image pickup device 4.

As mentioned above, the image pickup device 4 of this embodiment switches the voltage VL of the signal φ_{VPS} given to the pixels G₁₁ to Gₘₙ shown in FIG. 5, thereby can change the inflection point where the linear conversion operation is switched to the logarithmic conversion operation.

Here, as a characteristic of the output signal of the image pickup device 4, as the voltage VL is lowered, the rate of the brightness of the photographic subject to be linearly converted is increased. Therefore, when moving up the inflection point, that is, when increasing the rate of the brightness of the photographic subject to be linearly converted, the voltage VL may be reduced. In this way, the inflection point changing unit 25, to change the inflection point of the image pickup device 4 to the decided inflection point, calculates the voltage VL of the signal φ_{VPS} given to the pixels G₁₁ to Gₘₙ.

Further, a constitution may be used that an LUT prepared beforehand by making the brightness distribution of the sub-photographic subject positioned at a shortest distance within the arrival range of strobo light and voltage VL correspond to each other is stored in the inflection point changing unit 25 and the voltage VL is calculated using the LUT.

Furthermore, the inflection point changing unit 25 has a D-A converter 38, converts the calculated voltage VL to analog data, and inputs it to the pixels G₁₁ to Gₘₙ of the image pickup device 4, thus the inflection point of the image pickup device 4 is changed to an optimum inflection point.

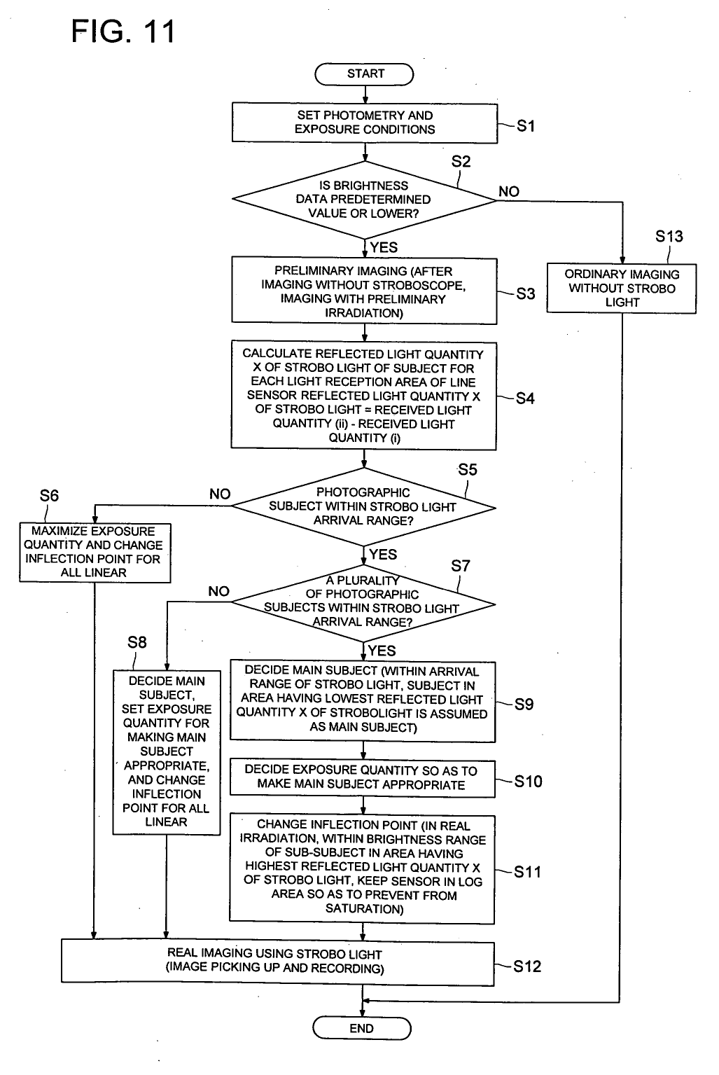

Next, the operation of the image pickup apparatus 1 of this embodiment will be explained by referring to the flow chart shown in FIG. 11.

The system control unit 8, when the power source of the image pickup apparatus 1 is turned on, picks up images by the image pickup device 4 every predetermined cycle, for example, every 15 fps and successively displays the picked-up images on the monitor 12 as preview screens. Further, the inflection point changing unit 25, on the basis of the AE evaluation value calculated by picking up the preview screens, can change the inflection point every time so as to prevent the high brightness area of the output signal of the image pickup device 4 from saturation.

Then, when a user half-presses the release switch 17, the photometry is started (Step S1). Namely, when the preview screens are picked up and the AE evaluation value calculation unit 33 detects the AE evaluation value, the system control unit 8, from the AE evaluation value, for example, the mean brightness value of all the screens of the monitor 12, decides the stop value, shutter speed, and imaging sensitivity which are exposure conditions of the real imaging. Further, in the image pickup, the inflection point changing unit 25 minimizes the voltage VL impressed to the image pickup device 4, thereby may always make the image pickup device 4 perform the linear conversion operation, and may put the image pickup device 4 into the state capable of performing both linear conversion operation and logarithmic conversion operation.

Next, the system control unit 8 judges whether or not to use the stroboscope as an irradiation unit 6 at time of imaging (Step S2). In this embodiment, the system control unit 8 calculates the mean brightness value of all the preview screens from the AE evaluation value and when the mean brightness value is not larger than a predetermined brightness value, judges use of the stroboscope at time of imaging. On the other hand, when the mean brightness value is the predetermined brightness value or larger, the system control unit 8 performs the ordinary image pickup operation without using the stroboscope (Step S13).

Next, when the user full-presses the release switch 17, the system control unit 8 executes imaging without using the stroboscope under the exposure condition at time of the real imaging and then executes imaging by preliminary irradiation at a light quantity of 1/n of that of the real irradiation. Further, in this image pickup, the inflection point changing. unit 25 minimizes the voltage VL impressed to the image pickup device 4, thereby may always make the image pickup device 4 perform the linear conversion operation, and may put the image pickup device 4 into the state capable of performing both linear conversion operation and logarithmic conversion operation.

Then, in the predetermined areas A to E, the line sensor 5 detects a sensor received light quantity (i) of reflected light of a photographic subject in imaging when the stroboscope is not used and a sensor received light quantity (ii) of reflected light of a photographic subject in imaging when preliminarily irradiated and transmits the respective received light quantities to the system control unit 8.

Next, the system control unit 8 obtains the difference between the sensor received light quantity (i) and the sensor received light quantity (ii), thereby calculates a reflected light quantity X according to the distance of the photographic subject in the respective areas A to E (Step S4).

Then, the system control unit 8 judges whether there are photographic subjects within the arrival range of strobo light or not (Step S5). As a result, when judging that there are no photographic subjects given contribution of the strobo light, the system control unit 8 sets the strobo light quantity at time of real imaging as a maximum (Step S6). Further, the inflection point changing unit 25 minimizes the voltage VL impressed to the image pickup device 4, thereby always puts the image pickup device 4 into the state of performing the linear conversion operation (Step S6). Further, here, when there are no photographic subjects given contribution of strobo light, to prevent consumption of the battery capacity, without emitting strobo light at time of real scanning, the stop and shutter speed are only combined appropriately for the mean brightness of the overall screen, thus the exposure operation may be performed. In this case, to make the contrast good, the system control unit 8 always puts the image pickup device 4 into the state of performing the linear conversion operation.

On the other hand, the system control unit 8, when judging that there are photographic subjects within the arrival range of strobo light, judges whether there are a plurality of photographic subjects or not (Step S7). As a result, the system control unit 8, when judging that there is one photographic subject, decides the photographic subject as a main photographic subject and then sets a strobo light quantity so as to make the exposure quantity of the decided main photographic subject appropriate (Step S8). Further, the inflection point changing unit 25 minimizes the voltage VL impressed to the image pickup device 4, thereby always puts the image pickup device 4 into the state of performing the linear conversion operation (Step S8).

On the other hand, the system control unit 8, when judging that there are a plurality of photographic subjects within the arrival range of strobo light, decides the photographic subject having a smallest reflected light quantity X within the arrival range of strobo light as a main photographic subject (Step S9) and then sets a strobo light quantity for making the exposure quantity of the decided main photographic subject appropriate (Step S10). At this time, the system control unit 8 judges whether there are differences in the reflected light quantity X according to the distance of each photographic subject within the arrival range of strobo light or not, and when there are no differences, judges as the same photographic subject, and when there are differences, judges as different photographic subjects. For example, in FIG. 9, the photographic subjects corresponding to the areas B and C are judged as the same photographic subject and the photographic subject corresponding to the area A is judged as a different photographic subject. And, the photographic subjects corresponding to the areas B and C where the received reflected light quantities X are minimum are decided as a main photographic subject.

Next, the inflection point changing unit 25 changes the inflection point so as to prevent the output signal from saturation within the brightness range of the sub-photographic subject having a largest reflected light quantity X within the arrival range of strobo light, thus the brightness range of the sub-photographic subject is positioned in the logarithmic area (Step S11). In this embodiment, to prevent the output signal from saturation within the brightness range of the area A shown in FIG. 9, the inflection point is changed. Namely, as shown in FIG. 10, to move the inflection point α shown in the graph (a) to the position of the inflection point β, the inflection point is moved down. By doing this, the output signal of the image pickup device 4 becomes the graph (b) and the brightness distribution of the area A is positioned in the logarithmic area. As mentioned above, the inflection point is changed so as to prevent the output signal from saturation within the brightness range of the sub-photographic subject having a largest reflected light quantity X, thus for the other sub-photographic subjects positioned at a shorter distance than the main photographic subject, the output signal is prevented from saturation.

Next, the inflection point changing unit 25, to change the inflection point of the image pickup device 4, calculates a voltage VL to be set in the image pickup device 4.

Next, the process moves to the real imaging and the system control unit 8 performs real irradiation by the stroboscope and also performs real imaging (Step S12). Namely, the system control unit 8 performs the real irradiation after start of exposure of the real imaging and ends the exposure after a lapse of predetermined time. Then, the pixels G₁₁ to Gₘₙ of the image pickup device 4 switches the linear conversion operation and logarithmic conversion operation at the inflection point changed by the inflection point changing unit 25, thereby converts photoelectrically the incident light. And, the concerned pixels output the electric signal obtained by photoelectric conversion to the signal processing unit 9.

And, the signal processing unit 9 performs a predetermined image process for the electric signal obtained by photoelectric conversion. Namely, when the amplifier 30 amplifies the electric signal outputted from the image pickup device 4 to a predetermined specified level, the A-D converter 31 converts the amplified electric signal to a digital signal.

Next, the black reference correction unit 32 corrects the black level which is a lowest brightness value to the reference value. Further, the AE evaluation calculation unit 33 detects an evaluation value necessary for automatic exposure (AE) from an electric signal after black reference correction and transmits it to the system control unit 8. On the other hand, the WB processing unit 34 calculates a correction coefficient from the electric signal after black reference correction, thereby adjusts the gain values of the color components of R, G, and B of the picked-up image, and correctly displays the white.

Further, the color interpolation unit 35 performs a color interpolation process of interpolating missing color components for each pixel. And, the color correction unit 36 corrects the color component values for each pixel and generates an image emphasizing the color tone of each pixel. Further, when the gradation conversion unit 37 performs a gamma correction process of correcting the gradation response characteristic of the image to an optimum curve according to the gamma value of the image pickup apparatus 1, the color space conversion unit 38 converts the color space from R, G, and B to Y, U, and V.

And, the recording unit 11 records image data outputted from the signal processing unit 9.

The embodiment of the present invention is the image pickup apparatus, including an image pickup device having a plurality of pixels for switching a linear conversion operation for linearly converting incident light to an electric signal and a logarithmic conversion operation for logarithmically converting it according to an incident light quantity, an irradiation unit for irradiating light at time of picking up an image of a photographic subject, and an inflection point changing unit, when imaging using the irradiation unit, for changing an inflection point which is a boundary between the linear area and the logarithmic area so as to prevent the output signal of the image pickup device from saturation within the brightness range of the photographic subject and to use the logarithmic area in priority.

Therefore, according to the embodiment of the present invention, when imaging using the irradiation unit, the inflection point is changed, and the logarithmic area is used in priority, thus the output signal of the image pickup device is prevented from saturation due to an excess of exposure quantity of a photographic subject, and a picked-up image can be prevented from overexposure. Further, in this case, only by changing the inflection point and without changing the exposure conditions, the influence on the brightness of the overall screen can be suppressed.

According to another aspect of the embodiment of the present invention, the image pickup apparatus includes an image pickup device having a plurality of pixels for switching a linear conversion operation for linearly converting incident light to an electric signal and a logarithmic conversion operation for logarithmically converting it according to an incident light quantity, an irradiation unit for irradiating light at time of picking up an image of a photographic subject, and an inflection point changing unit, when imaging using the irradiation unit, if there are a plurality of photographic subjects within the arrival range of irradiated light of the irradiation unit, for changing an inflection point which is a boundary between the linear area and the logarithmic area so as to prevent the output signal of the image pickup device from saturation within the brightness range of the photographic subject having a largest reflected light quantity of the irradiated light and to use the logarithmic area in priority.

Therefore, the prior art, when imaging using the irradiation unit, if there are a plurality of photographic subjects within the arrival range of irradiated light, although there is a possibility that particularly the exposure quantity of a photographic subject at a short distance may exceed the specified value, changes the inflection point on the basis of the photographic subject at a shortest distance, uses the logarithmic area in priority, thereby prevents the output signal of the image pickup device from saturation due to an excess of exposure quantity of the photographic subject, prevents the picked-up image from overexposure, and can obtain a good image. Simultaneously, for other photographic subjects in the arrival range of the irradiated light, output signals are prevented from saturation, and overexposure can be prevented. Further, in this case, only by changing the inflection point and without changing the exposure conditions, the influence on the brightness of the overall screen can be suppressed.

According to still another aspect of the embodiment of the present invention, the image pickup apparatus has a control unit for setting the irradiation quantity of the irradiation unit, among the plurality of photographic subjects aforementioned, so as to make the exposure quantity of the photographic subject having a smallest reflected light quantity of the irradiated light appropriate.

Therefore, the irradiation quantity of the irradiation unit is adjusted so as to make the exposure quantity of a photographic subject having a smallest reflected light quantity of irradiated light, that is, a photographic subject positioned at a longest distance from the image pickup apparatus appropriate, thus the picked up image of a photographic subject having a least degree of contribution of the irradiated light can be prevented from underexposure.

According to a further aspect of the embodiment of the present invention, the reflected light quantity of the irradiated light is a difference between the reflected light quantity when preliminarily imaged using the irradiation unit and the reflected light quantity when preliminarily imaged without using the irradiation unit.

Therefore, within the arrival distance of the irradiated light of the irradiation unit, the difference between the reflected light quantity when imaged using the irradiation unit and the reflected light when imaged without using the irradiation unit becomes the reflected light quantity according to the distance of the photographic subject, so that the relative distance of the photographic subject from the image pickup apparatus can be judged. Therefore, from the relative distance of the photographic subject from the image pickup apparatus, the degree of contribution of the irradiated light to the respective photographic subjects is confirmed, thus control of the inflection point and adjustment of the exposure quantity can be executed.

According to a still further aspect of the embodiment of the present invention, the inflection point changing unit changes the voltage set in the pixels of the image pickup device, thereby changes the inflection point.

Therefore, the inflection point of the output signal of the image pickup device can be changed.

As mentioned above, according to the image pickup apparatus of the present invention, in imaging using the irradiation unit, an output signal of the image pickup device is prevented from saturation, and overexposure of a picked-up image is prevented, and a good image can be obtained. In this case, only by changing the inflection point and without changing the exposure conditions, the influence on the brightness of the overall screen can be suppressed.

Further, when there are a plurality of photographic subjects within the arrival range of irradiated light, even if the distances up to the respective photographic subjects are different from each other, the influence on the brightness of the overall screen is suppressed without changing the exposure conditions, and the inflection point is changed on the basis of the photographic subject positioned at a shortest distance, thus the output signal of the image pickup device as a whole photographic subject is prevented from saturation, and overexposure of a picked-up image is prevented, and a good image can be obtained.

Further, when there are a plurality of photographic subjects within the arrival range of irradiated light, a picked-up image of a photographic subject positioned at a longest distance from the image pickup apparatus can be prevented from underexposure.

Further, from the relative distance of the photographic subject from the image pickup apparatus,. the degree of contribution of the irradiated light to the respective photographic subjects is confirmed, thus control of the inflection point and adjustment of the exposure quantity can be executed.

What is claimed is:

1. An image pickup apparatus, comprising:
an image pickup device provided with a plurality of pixels for picking up an image of a photographic subject, the image pickup device which has a linear conversion operation in which incident light is linearly converted to an electric signal and a logarithmic conversion operation in which the incident light is logarithmically converted to the electric signal, the liner conversion operation and the logarithmic conversion operation being switchable according to an amount of incident light;
a light irradiation section which throws irradiation light when picking up the image of the photographic subject; and
an inflection point changing section, when picking up the image of the photographic subject using the light irradiation section, which sets an inflection point which is a boundary between a liner area where the linear conversion operation is functional and a logarithmic area where the logarithmic conversion operation is functional in a manner of putting an priority on a use of the logarithmic area so as to prevent the electric signal outputted from the image pickup device from saturating in a brightness range of the photographic subject.

2. An image pickup apparatus, comprising:
an image pickup device provided with a plurality of pixels for picking up an image of a photographic subject, the image pickup device which has a linear conversion operation in which incident light is linearly converted to an electric signal and a logarithmic conversion operation in which the incident light is logarithmically converted to the electric signal, the liner conversion operation and the logarithmic conversion operation being switchable according to an amount of incident light;
a light irradiation section which throws irradiation light when picking up the image of the photographic subject;
a reflection light amount detection section which detects a reflection light amount from the photographic subject; and
an inflection point changing section, when picking up the image of the photographic subject using the light irradiation section, which sets an inflection point which is a boundary between a liner area where the linear conversion operation is functional and a logarithmic area where the logarithmic conversion operation is functional in a manner of putting an priority on a use of the logarithmic area for preventing the electric signal outputted from the image pickup device from saturating in a brightness range of a photographic subject which has the largest reflection light amount detected by the reflection light amount detection section in case that a plurality of photographic subjects exist within an arrival range of the irradiation light of the light irradiation section.

3. The image pick up apparatus of claim 2, comprising:
a control section which sets an irradiation amount of the light irradiation section so that an exposure amount of a photographic subject which has the smallest reflection light amount detected by the reflection light amount detection section is correct.

4. The image pickup apparatus of claim 2, wherein the reflection light amount is a difference between a reflection light amount when a preliminary exposure is conducted with a use of the light irradiation section and a reflection light amount when a preliminary exposure is conducted without a use of light irradiation section.

5. The image pickup apparatus of claim 3, wherein the reflection light amount is a difference between a reflection light amount when a preliminary exposure is conducted with a use of the light irradiation section and a reflection light amount when a preliminary exposure is conducted without a use of light irradiation section.

6. The image pickup apparatus of claim 1, comprising:
a circuit which supplies the pixels with a voltage for setting the inflection point, wherein the inflection point changing section changes the inflection point by changing a value of the voltage supplied to the pixels.

7. The image pickup apparatus of claim 2, comprising:
a circuit which supplies the pixels with a voltage for setting the inflection point,
wherein the inflection point changing section changes the inflection point by changing a value of the voltage supplied to the pixels.
